(19) United States
(12) Patent Application Publication
(10) Pub. No.: US 2026/0208325 A1
(43) Pub. Date: Jul. 23, 2026

(54) RATCHETING OPEN END WRENCH

(71) Applicant: Stanley Black & Decker MEA FZE, Dubai (AE)

(72) Inventors: Tsung-Chih Tsai, Taichung City (TW); Ting Wei Huang, Taichung City (TW)

(21) Appl. No.: 19/028,404

(22) Filed: Jan. 17, 2025

(51) Int. Cl. B25B 13/08; B25B 13/46

(52) U.S. Cl. CPC B25B 13/08; B25B 13/46

(57) ABSTRACT

A ratcheting open-end wrench for operation in narrow spaces. A ratcheting open-end wrench can include: a top jaw; a bottom jaw, the bottom jaw further including a cavity; a pin; an arm including a hole for the pin; and a spring. The top jaw and the bottom jaw together form a containing portion for receiving a fastener, where the arm is located within the cavity of the bottom jaw, with the pin enabling the arm to rotate within the cavity. The spring is located within the cavity of the bottom jaw, the spring connected on a first end to the arm and on a second end a floor of the cavity.

### BACKGROUND

### 1. Technical Field

The present disclosure relates to a ratcheting open-end wrench, and more specifically to an open-end wrench which allows for operation in narrow spaces.

### 2. Introduction

A wrench is a tool used to grip, tighten, loosen, or turn objects like nuts, bolts, and pipes. Wrenches have a handle attached to a containing portion, the containing portion having a first jaw and a second jaw, the jaws together defining a containing groove configured to receive fasteners or other workpieces. There are many occasions when it is desirable to apply a torque to a fastener (such as nuts, bolts, and in-line hydraulic fittings) using an open-end wrench, thereby allowing for rotation of the fastener with respect to a threaded member. For example, an open-end wrench can be useful in small work spaces where there may only be sufficient room to insert the wrench from the side.

### SUMMARY

Additional features and advantages of the disclosure will be set forth in the description that follows, and in part will be understood from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media which provide a technical solution to the technical problem described. A ratcheting open-end wrench for performing the concepts disclosed herein can include: a top jaw; a bottom jaw, the bottom jaw further comprising a cavity; a pin; an arm comprising a hole for the pin; and a spring; wherein: the top jaw and the bottom jaw together form a containing portion for receiving a fastener; the arm is located within the cavity of the bottom jaw, with the pin enabling the arm to rotate within the cavity; and the spring is located within the cavity of the bottom jaw, the spring connected on a first end to the arm and on a second end a floor of the cavity.

A ratcheting open-end wrench for performing the concepts disclosed herein can include: a top jaw; a bottom jaw, the bottom jaw further comprising a cavity; an arm; and a spring; wherein: the top jaw and the bottom jaw together form a containing portion for receiving a fastener; the arm is located within the cavity of the bottom jaw; the spring is located within the cavity of the bottom jaw, the spring connected on a first end to the arm and on a second end a floor of the cavity; upon receiving the fastener into the containing portion the fastener makes contact with the arm, the arm preventing the fastener from moving further into the containing portion, such that the fastener is in a first position within the containing portion; when a user applies first torque to the ratcheting open-end wrench in a first direction, the fastener is turned in the first direction while in the first position, the first direction being one of clockwise or counterclockwise; and when the user applies second torque to the ratcheting open-end wrench in a second direction, a ratcheting action occurs, moving the fastener to a second position within the containing portion, the second direction being opposite to the first direction.

A ratcheting open-end wrench for performing the concepts disclosed herein can include: a top jaw; a bottom jaw, the bottom jaw further comprising a cavity; an arm; and a spring; wherein: the top jaw and the bottom jaw together form a containing portion for receiving a fastener; the arm is located within the cavity of the bottom jaw; the spring is located within the cavity of the bottom jaw, the spring connected on a first end to the arm and on a second end a floor of the cavity; when a user applies first torque to the ratcheting open-end wrench in a first direction, the fastener is turned in the first direction while in a first position, the first direction being one of clockwise or counterclockwise; and when the user applies second torque to the ratcheting open-end wrench in a second direction, a ratcheting action occurs, moving the fastener to a second position within the containing portion, the second direction being opposite to the first direction.

### BRIEF DESCRIPTION OF THE DRAWINGS

FIG. 1 illustrates an exemplary exploded perspective view of a ratcheting open-end wrench;

FIG. 2 illustrates an example of a side view of the ratcheting open-end wrench, with a cavity for the ratcheting mechanism exposed;

FIG. 3A illustrates an example of the side view of the ratcheting open-end wrench, with the cavity for the ratcheting mechanism obfuscated;

FIG. 3B illustrates an exemplary perspective view of the ratcheting open-end wrench;

FIG. 4A illustrates an example of the ratcheting open-end wrench being used to engage with a fastener in a first position; and

FIG. 4B illustrates an example of the ratcheting open-end wrench being used to engage with the fastener in a second position.

### DETAILED DESCRIPTION

Various embodiments of the disclosure are described in detail below. While specific implementations are described, this is done for illustration purposes only. Other components and configurations may be used without parting from the spirit and scope of the disclosure.

Open-ended wrenches configured as disclosed herein are capable of conventional open-ended wrench functions while also providing the advantage of a ratchetable option to the wrench function. The ratchetable option allows the wrench to rotate in areas which the normal arc swing of a wrench is not an option. For example, rather than requiring a normal arc swing of 60°, the ratcheting effect of wrenches configured as disclosed herein can operate with an arc swing of 30°. The ratcheting effect of the wrench described herein occurs through a combination of (1) an arm integrated into one of the jaws of the wrench, the arm being spring loaded and applying an additional points of contact within the containing portion between the jaws; and (2) grooves within the opposite jaw. As the user applies torque in a first direction (e.g., clockwise or counter clockwise, often referred to as turning a fastener to the left or to the right), turning both the wrench and the fastener, the arm can move into a cavity within one of the jaws. As the user applies a reverse torque (e.g., the opposite direction of the first direction) to engage the ratcheting effect, the fastener can move slightly within the containing portion, allowing the spring to decompress and extend the arm back into the containing portion.

Consider the following example, where a user desires to turn a fastener clockwise, with the ratcheting action occurring when turning the wrench counterclockwise (in other circumstances, the user may desire to turn the fastener counterclockwise, with the ratcheting action occurring when turning the wrench clockwise). Initially, when the wrench is not being used and there is no fastener within the containing portion between the two jaws, the arm extends from one of the jaws into the containing portion of the wrench via the spring extending the arm. That is, initially the spring is not compressed, and the spring presses the arm into the containing portion between the jaws.

Continuing with the example, when a fastener is placed within the containing portion, the extended arm initially presses against the fastener, locking the fastener in place in a first position within the containing portion. As the user turns the wrench and fastener clockwise the wrench (1) applies torque to the fastener, while also (2) compressing the arm into the cavity within the jaw to which the arm is attached, until the end range of the wrench is reached. At that point the user can turn the wrench counterclockwise, causing ratcheting, thereby (1) moving the fastener into a distinct, second position within the containing portion, the second position having different contact points between the wrench and the fastener than the first position; and (2) moving the wrench back into the initial starting position. At this point the user can again turn the wrench and fastener clockwise, again rotating the fastener as desired with the fastener in the second position. Upon hitting the end range, the user can again turn the wrench counterclockwise, engaging in ratcheting, with the fastener moving from the second position back to the first position, the arm extending out of the cavity into the containing portion, and the wrench back once again into the initial starting position. This series of steps can continue until the user has sufficiently tightened or loosened the fastener.

Preferably, the arm which extends into the containing portion from one jaw of the wrench has a hole extending through it, allowing a pin to pass through the hole. The pin extends from one side of the jaw to the other, and allows the arm to rotate around the pin. Preferably, the pin has a length which matches the width/thickness of the jaw, such that the pin does not extend beyond the wrench. However, in other configurations, the pin can have a longer length (i.e., extending beyond the sides of the wrench's jaw on one or both sides), or a shorter length (i.e., not reaching the sides of the wrench. In some configurations the pin can be held in place using adhesives, whereas in other configurations the pin can be held in place via pressure, riveting, pinning, and/or friction. The pin can be made from any material known to those of skill in the art. A non-limiting example of pin material can include carbon steel. The diameter/radius of the pin can vary according to configuration.

The arm, when rotating on the pin, can be pressed into a cavity which exists within the same jaw which holds the arm. While the cavity can vary in shape, the cavity must be sufficiently large that it can contain the arm when a fastener is fully pressed into the containing portion of the wrench. In a preferred configuration, the cavity is a circular cavity, with the pin located towards the curved edge of the containing portion (i.e., away from the mouth of the wrench), such that the pin can rotate away from the mouth of the wrench when entering the containing portion, and towards the mouth of the wrench when being pressed into the cavity. While the width, depth, and shape of the cavity can vary, the jaw surrounds the cavity on three sides (i.e., the only opening to the cavity is through the containing portion, the other sides are covered by the jaw. The cavity can, for example, be machined using a T-shaped cutter, so the overall shape will be arc-shaped. The width and depth can vary according to different sizes and configurations. A spring can be placed within the cavity, the spring connected to a bottom of the cavity and the arm. The spring is preferably closer to the mouth of the wrench than the pin, such that when the arm is being pressed into the cavity, the spring becomes compressed. When the arm is no longer being pressed into the cavity, the spring expands, pressing the arm back into the containing portion of the wrench. The spring can be of any tension or materials known to those of skill in the art. For example, in some configurations, the spring can be piano wire. The size and strength of the spring can vary between configurations according to need.

The jaw containing the arm is preferably not flat from the mouth to the curved edge. Instead, the jaw contains (moving from the mouth to the curved edge) a first notch, a rounded protrusion, and a shallow concave hollow. The opposite jaw (i.e., the jaw not containing the cavity/arm) has a particular configuration which enables the fastener to ratchet between the two distinct sets of contact points. The opposite jaw has two concave hollows separated by a small protrusion, with the concave hollow closer to the mouth of the wrench being larger (i.e., extending deeper into the opposite jaw and wider) than the concave hollow closer to the curved edge.

The curved edge (i.e., the edge connecting the two jaws, which is furthest away from the mouth of the wrench), while rounded, is not as perfect rounded as a classic open ended wrench. Instead, the curved edge is made up of two edges which meet at a common vertex, one edge extending from the jaw containing the arm, the other edge extending from the opposite jaw containing the two concave hollows. Preferably, the edge extending from the jaw containing the arm to the common vertex is a straight line, whereas the edge extending from the opposite jaw containing the two concave hollows is slightly convex, extending out into the containing portion.

When in a first position (i.e., when the arm is extending into the containing portion), a fastener will have torque points with the wrench at (1) the arm, and (2) a corner of the larger concave hollow and a flat edge, the flat edge continuing to the mouth of the wrench. Additional contact between the fastener and the wrench may be found at the rounded protrusion of the jaw containing the arm, the small protrusion of the opposite jaw, and the slightly convex edge extending between the vertex and the opposite jaw. When in a second position (i.e., when the arm is pressed into the cavity), the fastener will have torque points at (1) the slightly convex edge extending from the vertex to the opposite jaw and (2) the rounded protrusion of the jaw containing the arm. The rounded protrusion of the opposite jaw may also be a point of contact with the fastener. The vertex is preferably rounded, though not as circular as a standard open-ended wrench.

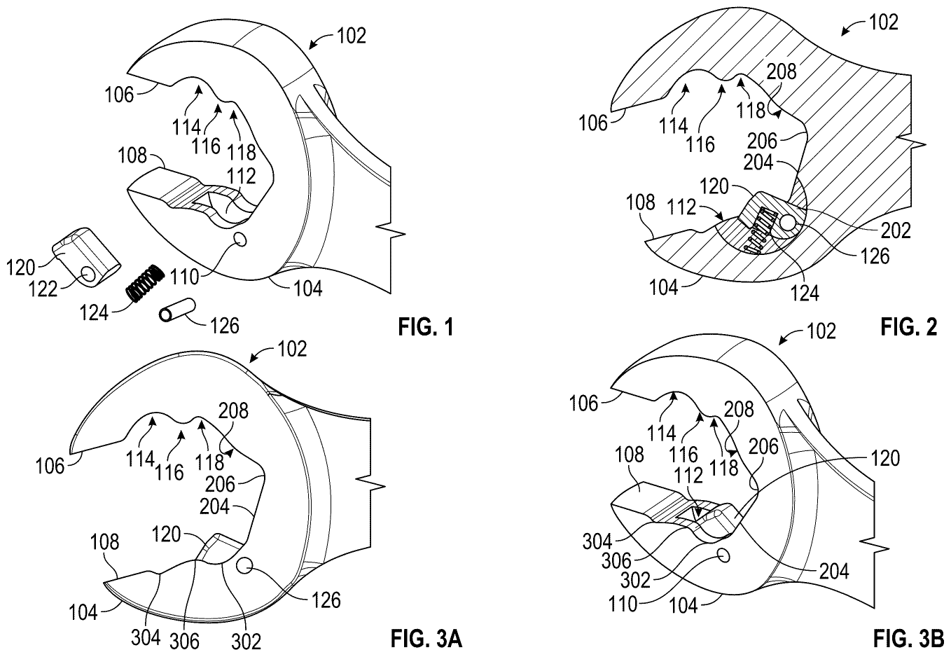

FIG. 1 illustrates an exemplary exploded perspective view of a ratcheting open-end wrench. As illustrated, there is an upper jaw 102 having (moving away from the mouth of the wrench) a flat edge 106, a larger concave hollow 114, a small protrusion 116, and a smaller concave hollow 118. A lower jaw 104 contains a flat edge 108, followed by a cavity 112, with a hole 110 in the lower jaw 104. An arm 120 which can rotate/pivot within the cavity 112 also has a hole 122. The arm 120, when placed in the cavity 112, can be held in place while also allowing the arm 120 to pivot/rotate by inserting the pin 126 through the hole 110 of the lower jaw 104, through the hole 122 of the arm 120, and through another hole on the opposite side of the lower jaw 104. around a pin 126. A spring 124 can also be inserted into the cavity 112, the spring connected to the lower jaw 104 and the arm 120, such when the arm 120 is pressed into the cavity 112, the spring 124 compresses, and when the arm 120 is not pressed into the cavity, the spring 124 decompresses.

FIG. 2 illustrates an example of a side view of the ratcheting open-end wrench, with a cavity 112 for the ratcheting mechanism exposed. As illustrated, the cavity 112 can have a circular (or semi-circular shape), with the cavity 112 extending beyond the edge of the arm 120. The spring 124 extends from the arm 120 to the floor of the cavity 112 (i.e., the bottom portion of the cavity 112). Also illustrated in FIG. 2 are the portions of the curved edge—specifically the straight edge 204 extending from the lower jaw 104 to the vertex 206, and the edge 208 extending from the opposite/upper jaw 102 to the vertex 206, the edge 208 extending out into the containing portion with a slight concave protrusion.

FIG. 3A illustrates an example of the side view of the ratcheting open-end wrench, with the cavity for the ratcheting mechanism obfuscated. Here, the lower jaw 104 contains the cavity 112, though the side of the lower jaw 104 prevents viewing the cavity 112 from this angle. The arm 120 is placed within the cavity 112, held in place by a pin 126 through hole 110. Also illustrated here are a first notch 304, a rounded protrusion 306, and a shallow concave hollow 302, with the rounded protrusion 306 being located near one end of the cavity 112, such that the end of the arm 120 can meet the top of the rounded protrusion 306 when being pressed into the cavity 112 (or extended from the cavity 112).

FIG. 3B illustrates an exemplary perspective view of the ratcheting open-end wrench. Here, as described with respect to FIG. 3A, one can see that the arm 120 is located in the cavity 112 of lower jaw 104.

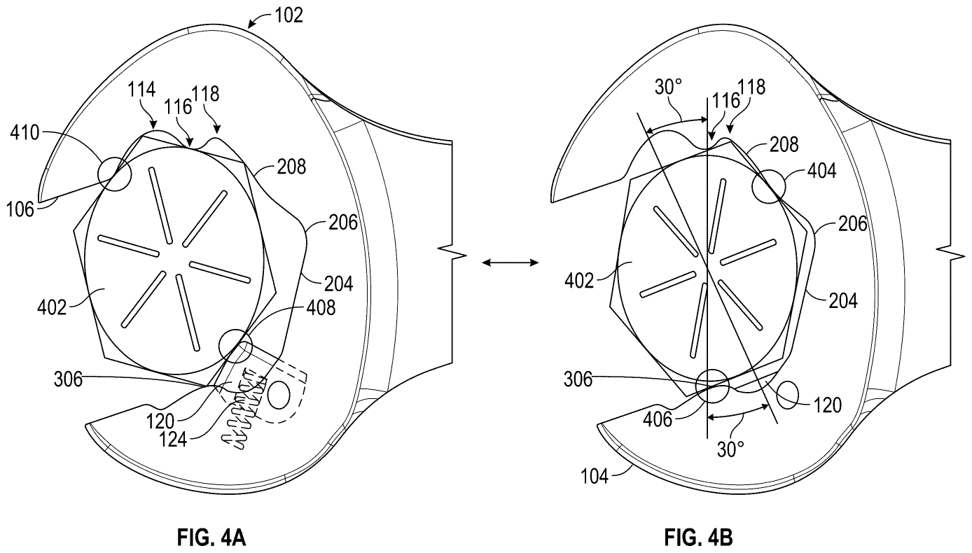

FIG. 4A illustrates an example of the ratcheting open-end wrench being used to engage with a fastener 402 in a first position, with arm 120 extended (via the spring 124 being extended). In this example, the fastener 402 cannot move completely flush to the vertex 206 of the curved edge, and instead makes contact with (1) the arm 120 at point 408, and (2) a corner 410 of the larger concave hollow 114 and the flat edge 106 of the upper jaw 102, the flat edge 106 continuing to the mouth of the wrench. Additional contact between the fastener 402 and the wrench may be found at the rounded protrusion 306 of the lower jaw 104 containing the arm, the small protrusion 116 of the upper jaw 102, and the (slightly convex) edge 208 extending between the vertex 206 and the upper jaw 102. As the user applies (in this example) clockwise torque to the wrench, the contact points 408, 410 can cause the fastener 402 to rotate. When the user applies counterclockwise torque to the wrench, the ratcheting function causes the wrench to move such that the fastener 402 shifts from its location in FIG. 4A, to its location in FIG. 4B with respect to the wrench (i.e., the fastener does not move, only the wrench moves, resulting in a change from FIG. 4A to FIG. 4B).

FIG. 4B illustrates an example of the ratcheting open-end wrench being used to engage with the fastener in a second position. Here, the fastener 402 is pushed deeper into the containing portion of the wrench, with corners of the fastener 402 extending into (or possibly touching) the vertex 206 and the smaller concave hollow 118. As illustrated, the fastener 402 is making contact 404 along the (slightly convex) edge 208 extending between the vertex 206 and the upper jaw 102, another contact point at the small protrusion 116, as well as contact 406 with the rounded protrusion 306 of the lower jaw 104. Using these contact points 404, 406, the user can again apply clockwise torque, rotating the fastener 402. Upon applying counterclockwise torque, the ratcheting function engages, rotating the wrench around the fastener 402 back to the position illustrated in FIG. 4A. In this manner, the user can rotate the wrench through a minimal arc swing (e.g., 30°), while still rotating the fastener 402.

In some configurations, in order for the ratcheting function to occur (and for the fastener 402 to shift between the positions illustrated in FIGS. 4A and 4B, the user may need to slightly disengage from the fastener, pulling back on the wrench such that the arm 120 resets, with the spring 124 decompressing/extending. At that point, the user can restart the process as illustrated in FIG. 4A or FIG. 4B, and otherwise described above.

Use of language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” are intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure. For example, unless otherwise explicitly indicated, the steps of a process or method may be performed in an order other than the example embodiments discussed above. Likewise, unless otherwise indicated, various components may be omitted, substituted, or arranged in a configuration other than the example embodiments discussed above.

Further aspects of the present disclosure are provided by the subject matter of the following clauses.

A ratcheting open-end wrench, comprising: a top jaw; a bottom jaw, the bottom jaw further comprising a cavity; a pin; an arm comprising a hole for the pin; and a spring; wherein:
the top jaw and the bottom jaw together form a containing portion for receiving a fastener; the arm is located within the cavity of the bottom jaw, with the pin enabling the arm to rotate within the cavity; and the spring is located within the cavity of the bottom jaw, the spring connected on a first end to the arm and on a second end a floor of the cavity.

The ratcheting open-end wrench of any preceding clause, wherein the top jaw further comprises, in order from a mouth of the containing portion to a curved edge of the containing portion: a flat edge; a first concave hollow; a protrusion; and a second concave hollow, such that: the flat edge is located next to the mouth of the containing portion; the first concave hollow is located between the flat edge and the protrusion; the protrusion is located between the first concave hollow and the second concave hollow; and the second concave hollow is located between the protrusion and the curved edge.

The ratcheting open-end wrench of any preceding clause, wherein the first concave hollow is larger than the second concave hollow.

The ratcheting open-end wrench of any preceding clause, wherein: upon receiving the fastener into the containing portion the fastener makes contact with the arm, the arm preventing the fastener from moving further into the containing portion, such that the fastener is in a first position within the containing portion; when a user applies first torque to the ratcheting open-end wrench in a first direction, the fastener is turned in the first direction while in the first position, the first direction being one of clockwise or counterclockwise; and when the user applies second torque to the ratcheting open-end wrench in a second direction, a ratcheting action occurs, moving the fastener to a second position within the containing portion, the second direction being opposite to the first direction.

The ratcheting open-end wrench of any preceding clause, wherein the ratcheting action allows the ratcheting open-end wrench to turn the fastener with a minimal arc swing of thirty degrees.

The ratcheting open-end wrench of any preceding clause, wherein: when the user applies third torque to the ratcheting open-end wrench in the first direction while the fastener is in the second position, the fastener is turned in the first direction; and when the user applies fourth torque to the ratcheting open-end wrench in the second direction while the fastener is in the second position, a second ratcheting action occurs, moving the fastener to the first position within the containing portion.

The ratcheting open-end wrench of any preceding clause, wherein: when the fastener is located in the second position, the user can pull the ratcheting open-end wrench away from the fastener, moving the fastener from the second position to the first position.

The ratcheting open-end wrench of any preceding clause, wherein the cavity can hold an entirety of the arm within the bottom jaw.

A ratcheting open-end wrench, comprising: a top jaw; a bottom jaw, the bottom jaw further comprising a cavity; an arm; and a spring; wherein: the top jaw and the bottom jaw together form a containing portion for receiving a fastener; the arm is located within the cavity of the bottom jaw; the spring is located within the cavity of the bottom jaw, the spring connected on a first end to the arm and on a second end a floor of the cavity; upon receiving the fastener into the containing portion the fastener makes contact with the arm, the arm preventing the fastener from moving further into the containing portion, such that the fastener is in a first position within the containing portion; when a user applies first torque to the ratcheting open-end wrench in a first direction, the fastener is turned in the first direction while in the first position, the first direction being one of clockwise or counterclockwise; and when the user applies second torque to the ratcheting open-end wrench in a second direction, a ratcheting action occurs, moving the fastener to a second position within the containing portion, the second direction being opposite to the first direction.

The ratcheting open-end wrench of any preceding clause, wherein the top jaw further comprises, in order from a mouth of the containing portion to a curved edge of the containing portion: a flat edge; a first concave hollow; a protrusion; and a second concave hollow, such that: the flat edge is located next to the mouth of the containing portion; the first concave hollow is located between the flat edge and the protrusion; the protrusion is located between the first concave hollow and the second concave hollow; and the second concave hollow is located between the protrusion and the curved edge.

The ratcheting open-end wrench of any preceding clause, wherein the first concave hollow is larger than the second concave hollow.

The ratcheting open-end wrench of any preceding clause, wherein the ratcheting action allows the ratcheting open-end wrench to turn the fastener with a minimal arc swing of thirty degrees.

The ratcheting open-end wrench of any preceding clause, wherein: when the user applies third torque to the ratcheting open-end wrench in the first direction while the fastener is in the second position, the fastener is turned in the first direction; and when the user applies fourth torque to the ratcheting open-end wrench in the second direction while the fastener is in the second position, a second ratcheting action occurs, moving the fastener to the first position within the containing portion.

The ratcheting open-end wrench of any preceding clause, wherein: when the fastener is located in the second position, the user can pull the ratcheting open-end wrench away from the fastener, moving the fastener from the second position to the first position.

The ratcheting open-end wrench of any preceding clause, wherein the cavity can hold an entirety of the arm within the bottom jaw.

The ratcheting open-end wrench of any preceding clause, wherein the cavity is of a semi-circular shape within the bottom jaw, such that access to the cavity is only found within the containing portion.

The ratcheting open-end wrench of any preceding clause, wherein the first position and the second position have distinct locations within the containing portion, such that a centerpoint of the fastener changes when moving the fastener between the first position and the second position.

A ratcheting open-end wrench, comprising: a top jaw; a bottom jaw, the bottom jaw further comprising a cavity; an arm; and a spring; wherein: the top jaw and the bottom jaw together form a containing portion for receiving a fastener; the arm is located within the cavity of the bottom jaw; the spring is located within the cavity of the bottom jaw, the spring connected on a first end to the arm and on a second end a floor of the cavity; when a user applies first torque to the ratcheting open-end wrench in a first direction, the fastener is turned in the first direction while in a first position, the first direction being one of clockwise or counterclockwise; and when the user applies second torque to the ratcheting open-end wrench in a second direction, a ratcheting action occurs, moving the fastener to a second position within the containing portion, the second direction being opposite to the first direction.

The ratcheting open-end wrench of any preceding clause, wherein the ratcheting action allows the ratcheting open-end wrench to turn the fastener with a minimal arc swing of thirty degrees.

The ratcheting open-end wrench of any preceding clause, wherein: when the user applies third torque to the ratcheting open-end wrench in the first direction while the fastener is in the second position, the fastener is turned in the first direction; and when the user applies fourth torque to the ratcheting open-end wrench in the second direction while the fastener is in the second position, a second ratcheting action occurs, moving the fastener to the first position within the containing portion.

We claim:

1. A ratcheting open-end wrench, comprising:
a top jaw;
a bottom jaw, the bottom jaw further comprising a cavity;
a pin;
an arm comprising a hole for the pin; and
a spring;
wherein:
the top jaw and the bottom jaw together form a containing portion for receiving a fastener;
the arm is located within the cavity of the bottom jaw, with the pin enabling the arm to rotate within the cavity; and
the spring is located within the cavity of the bottom jaw, the spring connected on a first end to the arm and on a second end a floor of the cavity.

2. The ratcheting open-end wrench of claim 1, wherein the top jaw further comprises, in order from a mouth of the containing portion to a curved edge of the containing portion:
a flat edge;
a first concave hollow;
a protrusion; and
a second concave hollow,
such that:
the flat edge is located next to the mouth of the containing portion;
the first concave hollow is located between the flat edge and the protrusion;
the protrusion is located between the first concave hollow and the second concave hollow; and
the second concave hollow is located between the protrusion and the curved edge.

3. The ratcheting open-end wrench of claim 2, wherein the first concave hollow is larger than the second concave hollow.

4. The ratcheting open-end wrench of claim 1, wherein:
upon receiving the fastener into the containing portion the fastener makes contact with the arm, the arm preventing the fastener from moving further into the containing portion, such that the fastener is in a first position within the containing portion;
when a user applies first torque to the ratcheting open-end wrench in a first direction, the fastener is turned in the first direction while in the first position, the first direction being one of clockwise or counterclockwise; and
when the user applies second torque to the ratcheting open-end wrench in a second direction, a ratcheting action occurs, moving the fastener to a second position within the containing portion, the second direction being opposite to the first direction.

5. The ratcheting open-end wrench of claim 4, wherein the ratcheting action allows the ratcheting open-end wrench to turn the fastener with a minimal arc swing of thirty degrees.

6. The ratcheting open-end wrench of claim 4, wherein:
when the user applies third torque to the ratcheting open-end wrench in the first direction while the fastener is in the second position, the fastener is turned in the first direction; and
when the user applies fourth torque to the ratcheting open-end wrench in the second direction while the fastener is in the second position, a second ratcheting action occurs, moving the fastener to the first position within the containing portion.

7. The ratcheting open-end wrench of claim 4, wherein:
when the fastener is located in the second position, the user can pull the ratcheting open-end wrench away from the fastener, moving the fastener from the second position to the first position.

8. The ratcheting open-end wrench of claim 1, wherein the cavity can hold an entirety of the arm within the bottom jaw.

9. A ratcheting open-end wrench, comprising:
a top jaw;
a bottom jaw, the bottom jaw further comprising a cavity;
an arm; and
a spring;
wherein:
the top jaw and the bottom jaw together form a containing portion for receiving a fastener;
the arm is located within the cavity of the bottom jaw;
the spring is located within the cavity of the bottom jaw, the spring connected on a first end to the arm and on a second end a floor of the cavity;
upon receiving the fastener into the containing portion the fastener makes contact with the arm, the arm preventing the fastener from moving further into the containing portion, such that the fastener is in a first position within the containing portion;
when a user applies first torque to the ratcheting open-end wrench in a first direction, the fastener is turned in the first direction while in the first position, the first direction being one of clockwise or counterclockwise; and
when the user applies second torque to the ratcheting open-end wrench in a second direction, a ratcheting action occurs, moving the fastener to a second position within the containing portion, the second direction being opposite to the first direction.

10. The ratcheting open-end wrench of claim 9, wherein the top jaw further comprises, in order from a mouth of the containing portion to a curved edge of the containing portion:
a flat edge;
a first concave hollow;
a protrusion; and
a second concave hollow,
such that:
the flat edge is located next to the mouth of the containing portion;
the first concave hollow is located between the flat edge and the protrusion;
the protrusion is located between the first concave hollow and the second concave hollow; and
the second concave hollow is located between the protrusion and the curved edge.

11. The ratcheting open-end wrench of claim 10, wherein the first concave hollow is larger than the second concave hollow.

12. The ratcheting open-end wrench of claim 9, wherein the ratcheting action allows the ratcheting open-end wrench to turn the fastener with a minimal arc swing of thirty degrees.

13. The ratcheting open-end wrench of claim 9, wherein:
when the user applies third torque to the ratcheting open-end wrench in the first direction while the fastener is in the second position, the fastener is turned in the first direction; and
when the user applies fourth torque to the ratcheting open-end wrench in the second direction while the fastener is in the second position, a second ratcheting action occurs, moving the fastener to the first position within the containing portion.

14. The ratcheting open-end wrench of claim 9, wherein:
when the fastener is located in the second position, the user can pull the ratcheting open-end wrench away from the fastener, moving the fastener from the second position to the first position.

15. The ratcheting open-end wrench of claim 9, wherein the cavity can hold an entirety of the arm within the bottom jaw.

16. The ratcheting open-end wrench of claim 9, wherein the cavity is of a semi-circular shape within the bottom jaw, such that access to the cavity is only found within the containing portion.

17. The ratcheting open-end wrench of claim 9, wherein the first position and the second position have distinct locations within the containing portion, such that a centerpoint of the fastener changes when moving the fastener between the first position and the second position.

18. A ratcheting open-end wrench, comprising:
a top jaw;
a bottom jaw, the bottom jaw further comprising a cavity;
an arm; and
a spring;
wherein:
the top jaw and the bottom jaw together form a containing portion for receiving a fastener;
the arm is located within the cavity of the bottom jaw;
the spring is located within the cavity of the bottom jaw, the spring connected on a first end to the arm and on a second end a floor of the cavity;
when a user applies first torque to the ratcheting open-end wrench in a first direction, the fastener is turned in the first direction while in a first position, the first direction being one of clockwise or counterclockwise; and
when the user applies second torque to the ratcheting open-end wrench in a second direction, a ratcheting action occurs, moving the fastener to a second position within the containing portion, the second direction being opposite to the first direction.

19. The ratcheting open-end wrench of claim 18, wherein the ratcheting action allows the ratcheting open-end wrench to turn the fastener with a minimal arc swing of thirty degrees.

20. The ratcheting open-end wrench of claim 18, wherein:
when the user applies third torque to the ratcheting open-end wrench in the first direction while the fastener is in the second position, the fastener is turned in the first direction; and
when the user applies fourth torque to the ratcheting open-end wrench in the second direction while the fastener is in the second position, a second ratcheting action occurs, moving the fastener to the first position within the containing portion.
